(19) United States
(12) Patent Application Publication
(10) Pub. No.: US 2026/0141524 A1
(43) Pub. Date: May 21, 2026

(54) Computer-Implemented Method for Automatically Rating Image Data

(71) Applicant: Siemens Healthineers AG, Forchheim (DE)

(72) Inventor: Mario Zeller, Erlangen (DE)

(73) Assignee: Siemens Healthineers AG, Forchheim (DE)

(21) Appl. No.: 19/390,746

(22) Filed: Nov. 17, 2025

(30) Foreign Application Priority Data
Nov. 18, 2024 (EP) 24213536.6

(51) Int. Cl. G06T 7/00; G06T 7/11; G06T 11/00

(52) U.S. Cl. CPC G06T 7/0014; G06T 7/11; G06T 12/20; G06T 12/30; G06T 2207/10088; G06T 2207/20076; G06T 2207/20081; G06T 2207/20084; G06T 2207/30004; G06T 2207/30168

(57) ABSTRACT

The disclosure relates to a computer-implemented method for automatically rating image data, in particular medical image data, in terms of the image quality that can be achieved with an image reconstruction procedure applied to the image data, wherein the method comprises the following method steps: receiving and/or generating at least one characterization parameter, which characterizes a signal-to-noise ratio of the image data; applying an evaluation algorithm to the at least one characterization parameter, wherein the evaluation algorithm is configured to generate at least on the basis of the characterization parameter an assessment parameter, which characterizes the image quality that can be achieved with the image reconstruction procedure, so that the assessment parameter is generated as a rating of the achievable image quality.

### CROSS-REFERENCE TO RELATED APPLICATIONS

The present application claims priority to and the benefit of European patent application no. EP 24213536.6, filed on Nov. 18, 2024, the contents of which are incorporated herein by reference in their entirety.

### TECHNICAL FIELD

The present disclosure relates to a computer-implemented method for automatically rating image data, to a computer program product, and to a medical imaging device.

### BACKGROUND

There are various approaches to using image reconstruction methods to facilitate an improvement in image quality in imaging methods, for example magnetic resonance methods (MR methods). In particular, the signal-to-noise ratio (SNR) can be improved by employing a suitable image reconstruction procedure. Newer image reconstruction procedures based on deep learning, for instance Deep Resolve Boost (DBR), allow for a significantly improved denoising performance compared with conventional procedures such as GRAPPA (Generalized Autocalibrating Partially Parallel Acquisitions). As a result, it is possible to speed up the image acquisition, for example, while still generally having improved image quality. However, one problem with employing a deep learning method for image reconstruction is that, when the input SNR is very low, the result is not noise amplification, as is the case in conventional procedures, but increased smoothing in the image data. This means that the existing noise behavior, for instance the absence of fine structures, is not immediately apparent on the image data and, in particular for radiologists familiar with more traditional procedures, is often difficult to recognize. It is not immediately obvious from the image data corrected (smoothed) in this way whether, for the device setting used, noise that is generally too high is occurring or has occurred. This can complicate or distort the medical diagnosis. For example, incorrectly selected parameters can lead to a significant reduction in the SNR, for instance by a factor of 5, although this is not immediately recognizable in the image data because of the smoothing that occurs. As a result, however, fine structures that would be distinctly recognizable given suitable parameter settings are blurred and can no longer be identified clearly.

### SUMMARY

Therefore, an object of the present disclosure is to provide a method which provides an automatic judgment of whether image data of an adequate image quality is available and/or whether selected parameter settings are suitably selected for an imaging procedure. For example, it is desirable to have a facility to assist the selection of a suitable SNR level when setting scan parameters.

This object is achieved by the various embodiments as discussed herein, including those described in the claims.

According to the disclosure, a computer-implemented method is provided for automatically rating image data, e.g. medical image data, in terms of the image quality that can be achieved with an image reconstruction procedure applied to the image data, wherein the method comprises the following method steps: receiving and/or generating at least one characterization parameter, which characterizes a signal-to-noise ratio of the image data; applying an evaluation algorithm to the at least one characterization parameter, wherein the evaluation algorithm is configured to generate on the basis of the at least one characterization parameter at least one assessment parameter, which characterizes the image quality that can be achieved with the image reconstruction procedure, so that the at least one assessment parameter is generated as a rating of the achievable image quality.

In the fields of MR methods and computed tomography, it should be possible to analyze medical data precisely and correctly, which means that it is important to apply, correctly, an image reconstruction procedure that follows the acquisition of the image data and to correctly understand the reconstructed images. An image reconstruction procedure is generally understood to be a procedure that is used to translate raw image data, for example MR data in k-space, into the image domain, i.e. to produce actual images. Image reconstruction procedures, e.g. as part of MR imaging, are generally known. The method according to the disclosure advantageously allows the image data resulting from the image reconstruction procedure to be rated in terms of its image quality or expected image quality so that a user receives feedback about the extent to which he has obtained, or can obtain, any usable data with the image data, for example whether set setup parameters of a scan have been selected correctly. For example, it can be provided to be able to assess even before a measurement whether the measurement is of any use.

A particularly relevant parameter for the achievable image quality is signal-to-noise ratio (SNR). In a first method step, the at least one characterization parameter is received and/or generated. The characterization parameter is generally a parameter that is related to the SNR or from which the SNR can be derived. The at least one characterization parameter may be the SNR, for example. It can be provided that the SNR is fed into the method as a characterization parameter. The at least one characterization parameter need not necessarily be directly the SNR, however. For example, a characterization parameter can be proportional to the SNR. It can be provided that the at least one characterization parameter, e.g. a plurality of characterization parameters, is/are suitable for the SNR to be calculated or deduced therefrom.

The evaluation algorithm is applied to the at least one characterization parameter, for example to an SNR, thereby generating an output value, namely the assessment parameter, by means of which the image quality of the image data is assessed. An evaluation algorithm can generally be understood to be an algorithm that facilitates an appraisal or rating on the basis of input data. In this case, the at least one characterization parameter is the input for the evaluation algorithm. The evaluation algorithm can be configured to generate the assessment parameter e.g. by means of a linkage made in advance between characterization parameters and each associated image quality. The assessment parameter is generally a metric of the image quality that can be achieved with the image data and the image reconstruction procedure. The assessment parameter can be a numerical value. For example, the assessment parameter can be a value on a rating scale. The assessment parameter can optionally be a rating expressed in words or the basis for a rating expressed in words. A rating expressed in words can be, for example, “adequate image quality” or “insufficient image quality.” In a further step, it is provided that a report is output to a user that comprises the assessment parameter or a message based on the assessment parameter. For example, the assessment parameter can be a numerical value, on the basis of which a rating expressed in words is output. The assessment parameter can serve as an aid to guide the user as to whether his set scan parameters are/were suitable for an intended diagnosis.

This is advantageous e.g. for preventing diagnostic errors. The assessment parameter can comprise specific information about the image quality. For example, the assessment parameter can comprise information about an expected blurring of the image data, e.g. measured in pixels and/or voxels. For example, the assessment parameter itself, or a report based thereon, can comprise the following variants: “an average blurring by 1.1 pixels and a maximum blurring by 1.5 pixels can be expected with the chosen settings,” “an average blurring by 1.4 pixels and a maximum blurring by 2.5 pixels can be expected with the chosen settings. Caution: small structures may no longer be visible with these settings.”

The term “image quality” may be understood e.g. in the sense of an informative, in particular diagnostic, value of the image data. An informative value of the image data can refer e.g. to the information content of the image data. For example, the image quality can comprise a level of detail contained in the image data. It can be relevant, for example, whether certain structures, for instance an organ or a disease characteristic of an organ, are fundamentally recognizable. If the SNR is too low, many structures may no longer be recognizable, which can be associated with a low image quality. It can be established by means of the assessment parameter whether the image quality is adequate for an intended purpose of the image data. The computer-implemented method thereby delivers an easy-to-use rating tool that can be applied for different imaging methods and different reconstruction procedures. In addition, the characterization parameters as input values can be varied, if applicable, according to the imaging methods and reconstruction procedures.

According to an embodiment, the image reconstruction procedure to be rated is based on a trained neural network (NN), e.g. a neural network based on deep learning. In contrast with conventional methods, reconstruction procedures based on trained neural networks effectively deliver fast and clear image data, and therefore are of great importance in medicine, for example, in light of the rising demand for imaging-based examinations, because large data volumes can be processed quickly by means of the neural networks. A known NN-based image reconstruction procedure can be provided. As described in the introduction, the SNR is a problem e.g. in image reconstruction procedures based on neural networks, because too poor an SNR is often no longer immediately recognizable in the finished images and hence a poor image quality can often be recognized only with difficulty or without certainty. The method solves this problem by offering an option to use the assessment parameter to determine the actually achievable image quality. The method according to the disclosure can therefore be applied advantageously in NN-based image reconstruction procedures. The method can be applied advantageously e.g. also in conventional iterative reconstruction methods such as Compressed Sensing, for instance, as conventional iterative reconstruction methods such as Compressed Sensing, for example, are typically also affected by these problems.

According to an embodiment, the at least one characterization parameter is based on at least one protocol parameter value and/or on a measurement procedure, e.g. using the image data and/or further image data. The characterization parameters can result from protocol parameter values, which are given largely by the associated imaging method. For example, the at least one characterization parameter can be derived from the at least one protocol parameter value. The at least one characterization parameter may itself be at least one protocol parameter value. The at least one characterization parameter can be obtained by measurement by means of the measurement procedure, optionally by means of the imaging method. The deriving of the at least one characterization parameter from the at least one protocol parameter value can be used advantageously because it is a theoretical assessment and/or calculation that can be performed efficiently in time and/or at low cost. This can be particularly advantageous if a measurement with the imaging system is very expensive and time-consuming. At least one characterization parameter based on a measurement procedure can allow the assessment parameter to be determined more accurately and with relatively few assumptions, e.g. because the characterization data can be attributed directly to the measurement data of a specific device type of an imaging method.

According to an embodiment, the image data is magnetic resonance tomography image data, wherein the at least one protocol parameter value comprises one or more from: a field strength of a main magnet of the magnetic resonance tomography system, a set voxel size, a set number of averages, a set number of phase encoding steps, an acceleration factor of parallel imaging, a fat saturation technique used. Magnetic resonance tomography is one of the most frequently used imaging methods. The high operating costs of the MRT devices means that it is advantageous to determine the characterization parameters, e.g. the SNR, using various protocol parameters. One of the most decisive factors that influences the actual SNR during the measurement is the BO field of the main magnet, which can be directly proportional to the SNR. The preset voxel size likewise influences the SNR, and should be set sufficiently large to avoid too low an SNR. With larger voxels, more protons contribute to the signal, and therefore the SNR is typically proportional to the voxel size.

Other relevant factors that can affect the SNR are the set number of averages, the set number of phase encoding steps, an acceleration factor of parallel imaging, and a fat saturation technique used. The SNR can be improved by multiple measurements of a slice, i.e. a plurality of acquisitions and associated averages. The number of acquisitions that are measured and averaged in a slice is referred to as the number of averages. The number of phase encoding steps equals the number of different phase encodings that are applied. The SNR is typically proportional to the square root of the number of averages and the square root of the number of phase encoding steps. If the number of averages or of phase encoding steps is reduced, the measurement time is also reduced, which is why users often try to facilitate faster measurements by reducing these numbers. Reducing these numbers too far, however, can produce too low an SNR. The number of averages and of phase encoding steps should therefore be set, like the voxel size, such that the SNR is large enough. The facility to reduce the measurement times through parallel acquisition techniques using a plurality of receivers, e.g. a plurality of coil elements, that are used simultaneously, is generally known. The acceleration factor specifies the acceleration that can be achieved thereby. The SNR, however, is typically inversely proportional to the square root of the acceleration factor, i.e. is reduced with a larger acceleration factor. To ensure that fat tissue does not obstruct the view to the actual features to be detected, fat saturation techniques are used, for instance by using radiofrequency pulses to suppress the fat signal. Usually, however, this also reduces the actual signal, and therefore the fat saturation technique used also has an influence on the SNR. It is therefore advantageous to take into account the fat saturation technique as, or for, the at least one characterization parameter. Additionally or alternatively, one or more further protocol parameters can optionally be included such as, for example, the sequence type and/or the flip angle, which may possibly affect the SNR.

According to an embodiment, at least one of the at least one characterization parameters may be calculated on the basis of a formula using a mathematical formula, wherein the formula comprises the at least one protocol parameter value. The formula can comprise, for instance, the field strength of a main magnet of the magnetic resonance tomography system, the set voxel size, the set number of averages, the set number of phase encoding steps, the acceleration factor of parallel imaging, and/or the fat saturation technique used, etc. The complexity of the influencing variables on the SNR makes it almost impossible for the assessment to take into account all the influencing variables, e.g. because the association of the value pairs of characterization parameters and assessment parameters would take on ever more dimensions. It can be provided that the formula comprises a number of protocol parameter values that have an influence on the signal-to-noise ratio. For example, an assessment formula may be used that takes into account (e.g. only) the protocol parameters that are the most relevant to the signal-to-noise ratio. For example, a formula of the following form may be used:

$$SNR ∝ \frac{{B}_{0} * V * \sqrt{N} * \sqrt{PE} * f}{\sqrt{R}}$$

This formula shows the direct proportional relationship between the SNR and the field strength of the main magnet B₀, the voxel size V, the number of averages N, the phase encoding steps PE, and the fat saturation technique f used. The empirically chosen factor of the fat saturation can lie in particular in an interval between any suitable range of values, such as for instance between 0.3 to 09.99, between 0.5 and 0.95, between 0.7 and 0.9, etc. If parallel imaging R is meant to be used, this is also incorporated in the assessment of the SNR. The simple handling of the assessment formula makes it possible to generate a characterization parameter easily. As an example, if a trained algorithm, e.g. a neural network, is used for the evaluation algorithm, a formula can also be used to generate relatively easily a large number of value pairs that can be used to train the trained algorithm.

According to an embodiment, the measurement procedure is based on a noise scan without excitation pulse and/or comprises repeatedly measuring the same k-space lines and determining a mean value and/or a standard deviation thereof and/or forming a ratio of data from the edge of k-space to k-space center. The determining of the assessment parameters by measurement may e.g. be performed using the device that currently belongs to the imaging method, and although it is typically more time-consuming than the formula-based assessment, can deliver often particularly precise output values for a specific device. To generate as large a number as possible of value pairs of characterization parameters and assessment parameters, for instance for training purposes, multiple measurements can be carried out, from which a mean value and a standard deviation can be formed for measurements having the same protocol parameter settings. There are various options for determining the at least one characterization parameter and/or the SNR. One option is to carry out a pure noise-scan without excitation pulse, so that only noise is detected. A ratio may be formed between the standard deviation of the noise and a signal acquired in k-space, for example. The advantage of this method is that it is relatively easy to implement. A further option is to analyze k-space. The detected k-space edge lines may be interpreted e.g. as being representative of noise. The central k-space lines can be interpreted as being representative of a signal. A ratio may be formed between the k-space edge lines and the central k-space lines, from which a metric of the SNR can be ascertained. It is thereby possible to determine the SNR e.g. without having to measure additional data, because the image data that is acquired anyway as part of the main measurement may be used. The repeated measurement of the same k-space lines and determining a mean value and/or a standard deviation can allow the SNR to be assessed particularly precisely. For example, it can be assumed that the SNR is proportional to a ratio of mean value and standard deviation.

According to an embodiment, the at least one characterization parameter is the signal-to-noise ratio, wherein the signal-to-noise ratio is assessed optionally by means of a decision tree and/or a lookup table. Advantageously, a decision tree and/or a lookup table can constitute a particularly simple way to determine the signal-to-noise ratio. For example, calculated value pairs can be combined in the form of a lookup table and/or a decision tree. Optionally, manual determination of the signal-to-noise ratio can be provided. The input can be, for example, at least one measurement parameter value, on the basis of which the SNR is determined.

According to an embodiment, the evaluation algorithm is designed to generate the assessment parameter from the characterization parameter on the basis of a series of linked predetermined characterization parameters and predetermined assessment parameters. For example, the evaluation algorithm may be configured to output, when the at least one characterization parameter is input, for instance an SNR, an associated assessment parameter. This assessment parameter can be e.g. a qualitative value that rates whether a setting according to the at least one characterization parameter is suitable for an intended or associated image reconstruction procedure. For example, it can be ascertained thereby whether the measurement in the imaging method should be performed with other parameters, or, if it has already been performed, should be repeated.

According to an embodiment, the predetermined assessment parameters have been produced on the basis of applying pixel-wise perturbation in a set of example image data, wherein e.g. the predetermined assessment parameters are each based on a point spread function of the comparison of a reconstructed example image with and without the perturbation. Example image data is in general image data provided in advance that is similar to the image data for which the method is then meant to be applied. For instance, the example image data may have been acquired using an identical imaging system, or be a simulation of a corresponding acquisition. Advantageously, this embodiment can be used to reliably infer the assessment parameter from the characterization parameter in an automated manner.

The use of pixel-wise perturbation and the use of point spread functions to assess quality can be based e.g. on a method described by Kleineisel et al. 2023 in “Assessment of resolution and noise in magnetic resonance images reconstructed by data driven approaches,” Journal of Medical Physics, DOI: 10.1016/j.zemedi.2023.08.007. In this method, minimal perturbation is introduced for each pixel of an image, resulting in a noisy reconstructed reference image from which the original image is subtracted to leave only the perturbations, which can be represented as point spread functions. The magnitude of these point spread functions, e.g. the width of the peak, allows the blurring, or noise, to be quantified and hence the SNR to be determined according to the associated characterization parameters. For example, the width of the peak can be defined by means of the FWHM (full width at half maximum). In other words, the assessment parameter can comprise the FWHM. Optionally, the at least one assessment parameter can comprise a mean FWHM and a maximum FWHM. The mean FWHM can be the mean FWHM of the FWHM of a plurality of image lines in the image data. The maximum FWHM can be the maximum FWHM of the FWHM of the plurality of image lines in the image data. It has been found that this principle of pixel-wise perturbation can be applied extremely well in the context of this disclosure by using this method to link characterization parameters to assessment parameters. It can be optionally provided that a small image segment of the image data is selected, to which image segment this procedure is applied. This can advantageously save time. Alternatively or additionally, it can be provided to select from the image data specifically test points and/or only pixels that lie above a fixed threshold value, and to apply the pixel-wise perturbation thereto. It can be provided to apply the pixel-wise perturbation for different noise levels. This can be used advantageously to facilitate improved and more accurate linking of the characterization parameters to the assessment parameters, which e.g. have been determined from the point spread functions.

According to an embodiment, the predetermined assessment parameters are each determined on the basis of at least one conventionally reconstructed image, e.g. each on the basis of at least two conventionally reconstructed images of the same subject matter, and on the basis of a signal-to-noise ratio of the at least one conventionally reconstructed image. In other words, an assessed characterization parameter characteristic of the SNR can thereby be linked to the SNR (assessment parameter) that actually occurs in a reconstructed image. A conventionally reconstructed image is e.g. an image that has been reconstructed using an image reconstruction procedure that is not based on deep learning procedures, and/or that has been reconstructed using a reconstruction procedure in which noisy input data also leads to noise in the reconstructed image. An example of a conventional reconstruction procedure in this sense is GRAPPA. Two conventionally reconstructed images of the same subject matter are two images based on two different, for instance successive, measurements of the same subject matter. The two different measurements can be acquired e.g. using the same measurement parameters. The same subject matter means here that the same subject or the same object has been acquired, e.g. in the same manner.

For example, the same point in an organ of a patient may be acquired twice from the same perspective. The signal-to-noise ratio may be determined from two conventionally reconstructed images of the same subject matter by, for example, determining a ratio of a mean value of the two images and a standard deviation of the difference in the two images in at least one region of the two images, optionally in a plurality of regions and/or for the entire images. The signal-to-noise ratio can be determined, for example, with a single measurement by repeatedly adding artificially, before the reconstruction, noise of the same strength but different random distribution, and then performing a conventional image reconstruction for each image containing different added noise to obtain thereby a plurality of conventionally reconstructed images of the same subject matter.

Alternatively, a single measurement can be made, and then a reconstruction performed many times on the data using different added noise of identical strength but random distribution. For example, a pixel-by-pixel assessment of the noise amplification can be made from this information. A pixel-by-pixel assessment of this type can be performed in a similar way to procedures known in the prior art such as described in, for example, Robson, P. M., Grant, A. K., Madhuranthakam, A. J., Lattanzi, R., Sodickson, D. K. and McKenzie, C. A. (2008), Comprehensive quantification of signal-to-noise ratio and g-factor for image-based and k-space-based parallel imaging reconstructions. Magn. Reson. Med., 60:895-907. https://doi.org/10.1002/mrm.21728.

According to an embodiment, the predetermined characterization parameters are linked to the predetermined assessment parameters for the same example image data in each case. The example image data can be used in this way to configure the evaluation algorithm. As an example, this can ensure that the predetermined characterization parameters and the predetermined assessment parameters actually correspond to each other or can be associated with each other. Optionally, at least some of the example image data can be, or can have been, produced synthetically. For example, existing example data can be expanded by adding noise to the example data in order to produce further example data. For example, Gaussian noise can be added. Advantageously, it is thereby possible to produce larger volumes of example data from an originally relatively small amount of example data. The added noise can be used to influence the SNR. For example, a set of example image data can be used, and for all the example image data the at least one characterization parameter and the assessment parameter are determined in each case. It is thereby advantageously possible to determine relatively easily a set of associated predetermined characterization parameters and assessment parameters.

According to an embodiment, at least some of the predetermined assessment parameters have been linked to the predetermined characterization parameters manually, e.g. using a Likert scale. A manual variant can be a particularly simple solution to obtaining the predetermined assessment parameters as long as a suitable professional provides an opinion for the assessment parameters. In this case, the Likert scale is suitable as a rating tool that can be used manually. A Likert scale allows a qualitative statement to be made about the image quality. In the present method, an expert can be requested to state, for example by means of the Likert scale, whether an image quality of an example image is adequate for a specific purpose, for instance a medical analysis. For example, the expert can use the Likert scale to make a qualitative judgment of the type “adequate image quality,” “unsatisfactory image quality,” etc. Optionally, further gradings can be provided. For example, the gradings “adequate quality,” “adequate and good quality,” etc., can be provided. The Likert scale can comprise an intended use reference, for example. In an embodiment, gradings of the Likert scale may be provided for different types of image-related diagnoses. For example, gradings of the Likert scale can be of the type “generally unsatisfactory image quality,” “image quality adequate for diagnosis A,” “image quality adequate for diagnosis B,” etc.

According to an embodiment, the evaluation algorithm generates the assessment parameter from an assessment parameter lookup table based on the series, wherein in the assessment parameter lookup table at least one characterization parameter or a range of characterization parameters is associated with one assessment parameter in each case, according to a decision tree or according to an assessment formula. Based on these stored value pairs, when the evaluation algorithm is applied, an incoming characterization value can be associated automatically with an assessment parameter that provides the user with feedback about the image quality. This can advantageously convey a clear statement to the user. It can be provided e.g. that even when a combination of a plurality of characterization parameters are input, only one assessment parameter is output. The decision tree and/or the lookup table can be stored, for example, in the evaluation algorithm, and/or the evaluation algorithm can have access thereto. The decision tree can be based, for example, on the querying or examining of a plurality of characterization parameters, which e.g. may be checked one after the other. For example, the value of a first characterization parameter can be checked initially and, on the basis thereof, various requirements can be placed on the values of further characterization parameters.

For example, the magnitude of a field strength of the main magnet (e.g. 1.5 T or 3 T or 7 T) can be checked initially and, on the basis thereof, various minimum requirements for the number of averages or the number of phase encoding steps can be made, which should also be checked. The decision tree can have a plurality of paths to a positive assessment parameter and/or a plurality of paths to a negative assessment parameter. The lookup table can link, for example, specific values of characterization parameters to specific values of assessment parameters. For example, SNR values below a limit threshold can be linked to a negative assessment parameter. Advantageously, a decision tree and/or a lookup table can constitute a particularly simple way to implement the evaluation algorithm as long as relevant data is available. The assessment formula may be used to ascertain e.g. proportional relationships between the characterization parameters, e.g. the SNR, and an assessment parameter, e.g. an extent of blurring in the image data, which blurring is represented in the point spread functions. The assessment formula may be e.g. a proportionality formula. On the basis of one or more proportionality formulas, a user report based on threshold values can be generated, for example. For example, the threshold values can classify blurring into minimum, average, and maximum blurring. The assessment formula can have, for example, the following form: FWHM_mean (x)-ax²+bx+cx^{1/2}+d, where x is the characterization parameter, e.g. an SNR, and a, b, c, and d are factors. The factors may be ascertained for instance using classical fitting of the predetermined assessment parameters and predetermined characterization parameters (each as described herein).

According to an embodiment, the evaluation algorithm comprises a trained algorithm, e.g. a trained neural network, wherein the trained algorithm is configured to generate from an input of the at least one characterization parameter the assessment parameter as an output, wherein the trained algorithm is trained e.g. on the basis of the series of linked predetermined characterization parameters and predetermined assessment parameters, as described herein. The trained algorithm may be based e.g. on machine learning. In general, a trained algorithm based on machine learning can be understood in the sense that it imitates cognitive functions that can generally be associated with the human mind. For instance, by training on the basis of training data, an algorithm based on machine learning is capable of adapting to specific or new circumstances and recognizing and extrapolating patterns. A trained algorithm based on machine learning may also be referred to as a trained function or a trained model. In general, parameters of the algorithm based on machine learning can be adapted by training. In an embodiment, the parameters of the algorithm may be adapted iteratively by a plurality of training steps.

For example, a specific loss function can be optimized (e.g. minimized) during the training. In an embodiment, the trained algorithm may be a neural network (NN). The neural network may also be referred to as an artificial neural net (ANN), artificial neural network, or artificial neural network. For the purposes of this disclosure, a neural network with a relatively simple structural design can be provided. In an embodiment, a neural network may be provided that has an input layer, an output layer, and at least one hidden layer. For example, any suitable range such as e.g. 1 to 5, 1 to 3, etc., of hidden layers may be provided. For example, the neural network may comprise 2 hidden layers. The input layer may have one or more artificial neurons, e.g. one artificial neuron per intended characterization parameter. The output layer may e.g. comprise one or more artificial neurons. The hidden layers may e.g. each comprise a plurality of artificial neurons, e.g. more artificial neurons than the input layer. For example, the hidden layers may comprise any suitable range, such as 2 to 10, 2 to 6, etc., artificial neurons. The artificial neurons of the hidden layers may comprise rectifiers as the activation function. Corresponding units having a rectifier are typically referred to as a ReLU (rectified linear unit). In one variant, the trained algorithm may be trained to output a binary output such as “good” or “poor,” for example. Optionally, the trained algorithm may be trained to have at least one continuous value as an output option. The output value may be passed directly to a user, or a report based on the output value can be passed to a user. For example, if the output of the trained algorithm is a continuous value, a text message, for example, may be output depending on the continuous value.

To train the algorithm (e.g. the neural network), predetermined characterization parameters may be used as the input training data, and predetermined assessment parameters as the output training data (also known as the “ground truth”). For example, the input training data may be normalized for this purpose to a real number between 0 and 1. For example, an SNR with limit values between 0 and 250 can be transformed to the interval between 0 and 1. The volume of training data used may be made dependent on the number of trainable parameters. For a network architecture as described herein by way of example, a few hundred training datasets can be sufficient for the method according to the disclosure. During the training, the algorithm or the NN may be applied to the input training data to generate output values. The output values may comprise, for example, one or more numerical values, optionally on a continuous scale. The number of numerical values of the output values may e.g. equal the number of artificial neurons of the output layer. Weights of the algorithm or NN may be adapted recursively by comparing the output values with the output training data. Advantageously, it is possible to use the training data to ascertain relationships, for example proportional relationships, between the characterization parameters, e.g. the SNR, and an extent of blurring in the image data, which blurring is represented in the point spread functions.

A further aspect of the disclosure is a computer program product comprising commands which, when executed by a computer and/or by a control apparatus of a medical imaging device, cause this to perform the steps of the method as claimed in one of the preceding claims. The computer program product may provide the basis for performing any of the computer-implemented methods for automatic image rating as described herein. All the features and advantages of the method for rating the image quality may be transferred accordingly to the computer program product and/or the control apparatus of the medical imaging device, if applicable, with suitable modification. The computer program product may be stored, for example, on a computer-readable storage medium, e.g. a non-volatile storage medium. The storage medium may be, for example, a hard disk, an SSD, a flash memory, an online server, etc.

A further aspect is a medical imaging device (e.g. a magnetic resonance tomography device), comprising a control apparatus designed to perform any of the computer-implemented methods for automatic image rating as described herein. In general, the computer-implemented method for automatic image rating can be applied for different imaging methods having different image reconstruction procedures. All the features and advantages of the methods for rating the image quality can be transferred to the imaging device, if applicable with suitable modification.

Further advantages and characteristic features of the present disclosure appear in the following description with reference to the accompanying figures. The same features are used in each of the figures with the same reference signs, even if they are part of a different embodiment. It shall be understood that individual features that are explicitly described only for a specific embodiment may also be used in other embodiments of the disclosure, provided technical circumstances do not prohibit this.

### BRIEF DESCRIPTION OF THE DRAWINGS

In the figures:

FIG. 1 illustrates a flow diagram of an example computer-implemented method for automatically rating image data, according to an embodiment of the disclosure;

FIG. 2 illustrates a flow diagram of the example method step a), according to an embodiment of the disclosure;

FIG. 3 illustrates a flow diagram of an example training of a neural network, according to an embodiment of the present disclosure;

FIG. 4 illustrates an example artificial neural network, according to an embodiment of the disclosure; and

FIG. 5 illustrates an example medical imaging device, according to an embodiment of the disclosure.

### DETAILED DESCRIPTION OF THE DISCLOSURE

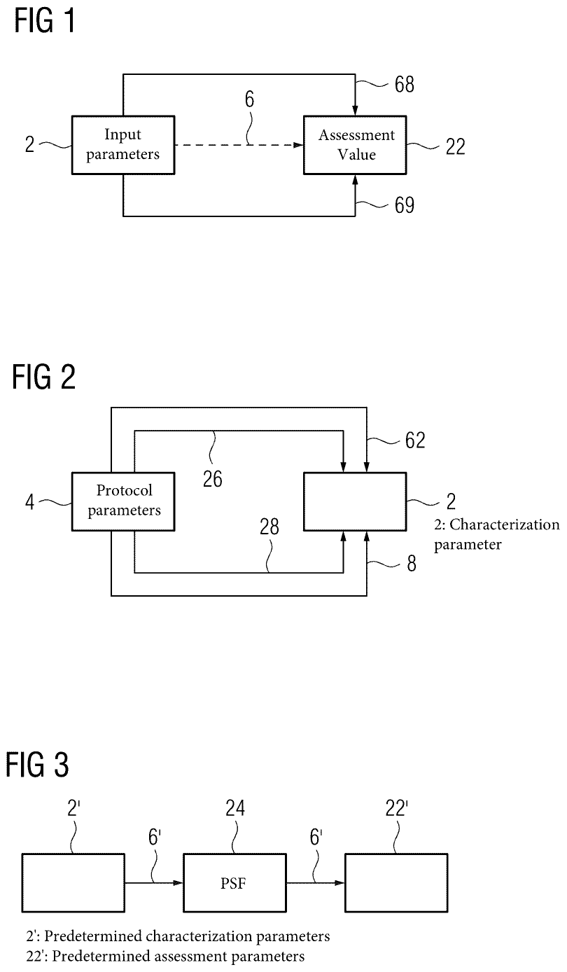

FIG. 1 illustrates a flow diagram of an example computer-implemented method for automatically rating image data, according to an embodiment of the disclosure. Specifically, FIG. 1 shows a flow diagram of a computer-implemented method for automatically rating image data according to an embodiment of the disclosure. The characterization parameters 2, e.g. the SNR, are fed as input parameters into the trained evaluation algorithm 6, which is based on a neural network, and which outputs by applying stored training data the output value, the assessment value 22, that can be associated with the input parameters. This assessment value 22 qualitatively rates the image quality of the image data which have been, or are meant to be, acquired on the basis of the characterization data 2 and have been, or are meant to be, corrected by means of an image reconstruction procedure. The linking of the characterization parameters and the assessment parameters can be made, for example, via a Likert scale 68 and/or a lookup table 69.

FIG. 2 illustrates a flow diagram of the example method step a), according to an embodiment of the disclosure. Specifically, FIG. 2 shows a flow diagram of an embodiment of the method step a) of the present disclosure. In the method step a) the characterization data 2, in particular the SNR, is generated by means of different protocol parameters 4. The protocol parameters therefore constitute setup parameters of the imaging method. In magnetic resonance tomography, e.g. the field strength of the main magnet, the set voxel size, the set number of averages, the set number of phase encoding steps, the acceleration factor of parallel imaging, and the fat saturation technique used, affect the SNR.

The protocol parameters 4 used for this can accordingly comprise e.g. some or all of these values. The associating of the SNR as characterization parameter 2 to the incoming protocol parameters 4 can be performed on the basis of a formula, by measurement and also manually. The formula-based assessment is performed by means of a mathematical formula 8, which e.g. describes the (inverse) proportionality of the protocol parameters 4 to the SNR. The acceleration factor of parallel imaging is typically inversely proportional to the SNR. The SNR, or a value related thereto, can also be determined by measurement. For example, the measurement procedure 62 can consist either of a noise scan without excitation pulse or in detecting different k-space lines, which are located either at the edge of k-space, corresponding to noise, or in the center of k-space, corresponding to the signal, and forming a ratio therebetween. When using a measurement procedure 62, the measurements may e.g. be performed repeatedly and at different noise levels, so that the characterization parameters can be formed as mean values. Alternatively, the characterization parameters may be associated with the incoming protocol parameters also manually by using a first lookup table 28 or a decision tree 28.

FIG. 3 illustrates a flow diagram of an example training of a neural network, according to an embodiment of the present disclosure. Specifically, FIG. 3 shows a flow diagram of an embodiment of the training of the trained algorithm or neural network according to an embodiment of the present disclosure. The trained algorithm or the neural network on which the evaluation algorithm 6 is based in this embodiment is trained using predetermined characterization parameters 2′ and predetermined assessment parameters 22′, to be able to link the incoming characterization parameters 2 to the associated assessment parameters 22 when applying the method. The training data is thus composed of the predetermined characterization parameters 2′ and the predetermined assessment parameters 22′. The predetermined assessment parameters 22′ used for the training can be determined or generated, for example, on the basis of introducing pixel-wise perturbation. This method based on pixel-wise perturbation can be performed for instance as described by Kleineisel et al. 2023, wherein applying pixel-wise perturbation 6′ in a set of example image data produces predetermined assessment parameters 22′, wherein these are based on a point spread function 24 of the comparison in each case of a reconstructed example image with and without the perturbation. The edge regions of the point spread functions 24 represent the noise behavior while the center shows the signal. The measure of the blurring of the signal can hence be ascertained by means of the point spread functions 24. To train the algorithm or the neural network, the predetermined characterization parameters and the predetermined assessment parameters may be provided as value pairs, wherein different value pairs are based e.g. on different noise levels and/or different protocol parameters employed.

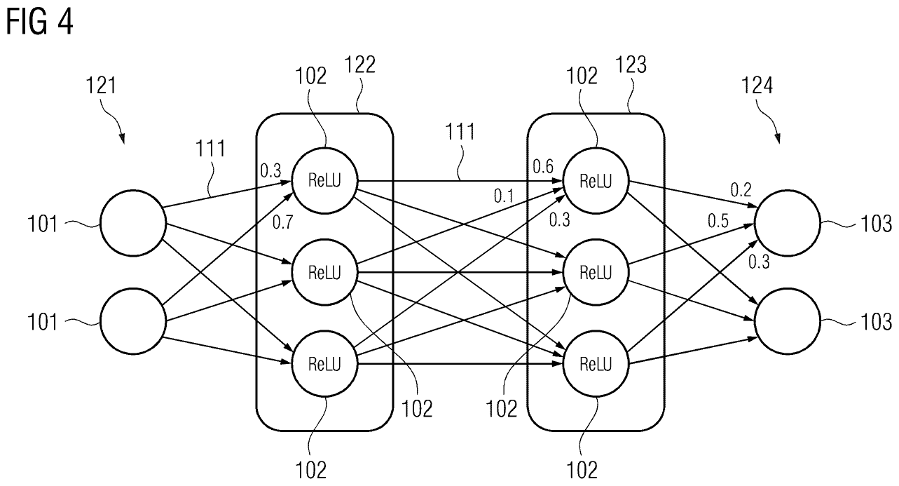

FIG. 4 illustrates an example artificial neural network, according to an embodiment of the disclosure. Specifically, FIG. 4 shows an (artificial) neural network according to an embodiment of the disclosure. The neural network comprises artificial neurons 101, 102, 103 and connections 111 between the artificial neurons 101, 102, 103. Each connection is a weighted link of a first artificial neuron 101, 102 to a further artificial neuron 102, 103. The various artificial neurons 101, 102, 103 in general are different, but can also be identical. The artificial neurons 101, 102, 103 are arranged in layers 121, 122, 123, 124, which have an order amongst themselves given by the connections 111. There is an input layer 121, an output layer 124, and two hidden layers 122, 123 between the input layer 121 and the output layer 124. The number of artificial neurons 101 in the input layer 121 may for instance equal the number of input values, in this case the number of characterization parameters 2. The number of artificial neurons 103 in the output layer 124 may e.g. equal the number of output values, in this case the number of assessment parameters 22. For example, each artificial neuron 101, 102, 103 may be assigned a real number. The values of the artificial neurons 101 in the input layer 121 here equal the input values or the characterization parameters 2, and the values of the artificial neurons 103 in the output layer 124 equal the output values or the assessment parameters 22. The connections 111 are likewise assigned real numbers, e.g. in the interval between 0 and 1, which are referred to as weights. These weights are typically adapted during the training. Some example values (0.3-0.7-0.6-0.1-0.3-0.2-0.5-0.3) are indicated here for weights of the connections. To determine the output values, the input values propagate through the neural network, where the values (x⁽ⁿ⁺¹⁾^{ⱼ}) of the respective artificial neurons 102, 103 (j) of the next layer (n+1) are each calculated on the basis of the values (x⁽ⁿ⁾^{ᵢ}) of the artificial neurons 101, 102 (i) of the previous layer (n) weighted by the weights (w⁽ⁿ⁾^{ᵢ}^{,j}) of the connections 111. This can be provided, for example, by the formula:

$${x}^{{( n + 1 )}_{j}} = f ( {\sum }_{i} {x}^{{( n )}_{i}} \times {w}^{{( n )}_{i} , j} ) ,$$

where ƒ is an activation function, which in the case of the hidden layers is in this embodiment a rectifier (“ReLU”) in each case. Alternative functions may include step functions or Sigmoid functions, for example. The rectifier may be provided e.g. according to the term ƒ(x)=max (0, x), where x is the input value of the particular artificial neuron. The input values or characterization parameters can be, for example, an SNR calculated by means of a formula, and the result can be a noise measurement or an SNR based on a noise measurement, or a noise value based on a noise measurement. Alternative input values are also conceivable, however. For example, the two input values could be a mean value and a standard deviation of a noise measurement. It is also possible to provide another number of input values, for example one SNR could be provided or a plurality of protocol parameter values could each be provided as an input value, for instance five or six protocol parameter values. The output values can be, for example, a mean FWHM and a maximum FWHM. Other output values and other numbers of output values (e.g. one output value or more than three output values) are also conceivable, however.

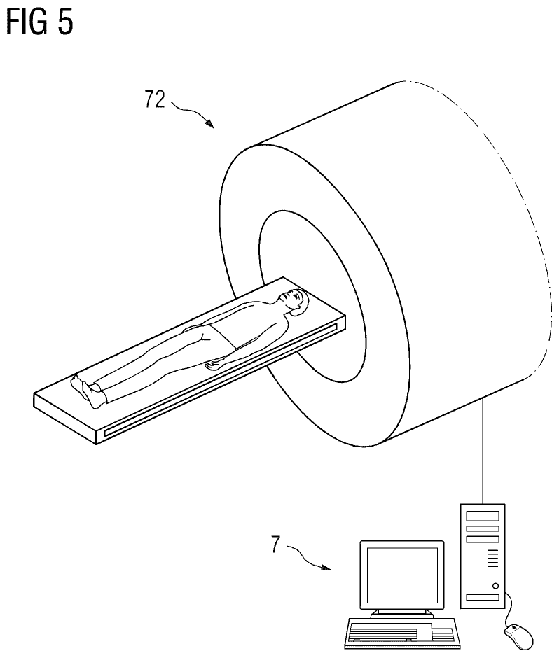

FIG. 5 illustrates an example medical imaging device, according to an embodiment of the disclosure. Specifically, FIG. 5 shows a medical imaging device 72 according to an embodiment of the disclosure, in which a magnetic resonance tomography device is connected to a control apparatus (also referred to herein as a controller or control circuitry), which is integrated in a computer 7. The computer-implemented method for automatically rating image data of the present disclosure runs via the computer 7, with the computer 7 or the control apparatus executing commands corresponding to the method, and outputting to the user a report about the quality of the acquired image data. As an example, an SNR of image data reconstructed using an image reconstruction procedure may be graded on the basis of blurring of the pixels of the image data into not adequate, minimally adequate, averagely adequate, and maximally adequate. Corresponding threshold values may be used to define the grading.

The various components described herein may be referred to as “units.” Such components may be implemented via any suitable combination of hardware and/or software components as applicable and/or known to achieve their intended respective functionality. This may include mechanical and/or electrical components, processors, processing circuitry, or other suitable hardware components, in addition to or instead of those discussed herein. Such components may be configured to operate independently, or configured to execute instructions or computer programs that are stored on a suitable computer-readable medium. Regardless of the particular implementation, such units, as applicable and relevant, may alternatively be referred to herein as “circuitry,” “controllers,” “processors,” or “processing circuitry,” or alternatively as noted herein.

What is claimed is:

1. A computer-implemented method for automatically rating image data in terms of an image quality that can be achieved with an image reconstruction procedure applied to the image data, the method comprising:
receiving and/or generating, via a control apparatus of a medical imaging device, at least one characterization parameter that characterizes a signal-to-noise ratio of the image data acquired by the medical imaging device, the at least one characterization parameter being used to control imaging parameters of the medical imaging device; and
applying an evaluation algorithm to the at least one characterization parameter,
wherein the evaluation algorithm is configured to generate, on the basis of the at least one characterization parameter, at least one assessment parameter comprising a qualitative value that characterizes the image quality that can be achieved with the image reconstruction procedure such that the at least one assessment parameter is generated as a rating of the achievable image quality for adjusting scan parameters of the medical imaging device.

2. The method as claimed in claim 1, wherein the image reconstruction procedure to be rated is based on a trained neural network.

3. The method as claimed in claim 1, wherein the at least one characterization parameter is based on at least one protocol parameter value and/or a measurement procedure.

4. The method as claimed in claim 3, wherein the image data comprises magnetic resonance tomography image data acquired via a magnetic resonance tomography system, and
wherein the at least one protocol parameter value comprises:
a field strength of a main magnet of the magnetic resonance tomography system,
a set voxel size,
a set number of averages,
a set number of phase encoding steps,
an acceleration factor of parallel imaging, and/or
a fat saturation technique.

5. The method as claimed in claim 3, wherein at least one of the at least one characterization parameters is calculated based on a mathematical formula comprising the at least one protocol parameter value.

6. The method as claimed in claim 3, wherein the measurement procedure is based on a noise scan without an excitation pulse.

7. The method as claimed in claim 3, wherein the measurement procedure comprises repeatedly measuring the same k-space lines and determining a mean value and/or a standard deviation of the same k-space lines.

8. The method as claimed in claim 3, wherein the measurement procedure comprises forming a ratio of data from an edge of k-space to k-space center.

9. The method as claimed in claim 1, wherein applying the evaluation algorithm comprises generating the assessment parameter from the characterization parameter based on a series of linked predetermined characterization parameters and predetermined assessment parameters.

10. The method as claimed in claim 9, further comprising:
generating the predetermined assessment parameters based on an application of pixel-wise perturbation in a set of reference image data,
wherein the predetermined assessment parameters are each based on a point spread function of a comparison of a reconstructed reference image with and without the perturbation.

11. The method as claimed in claim 9, further comprising:
determining the predetermined assessment parameters based on one or more reconstructed images and a signal-to-noise ratio of the one or more reconstructed images.

12. The method as claimed in claim 11, wherein the reconstructed images comprise the same subject matter.

13. The method as claimed in claim 9, wherein the predetermined characterization parameters are linked to the predetermined assessment parameters for the same reference image data in each case.

14. The method as claimed in claim 9, wherein at least a portion of the predetermined assessment parameters are linked to the predetermined characterization parameters using a Likert scale.

15. The method as claimed in claim 9, wherein applying the evaluation algorithm generates the assessment parameter from an assessment parameter lookup table based on the series, and
wherein, in the assessment parameter lookup table, at least one characterization parameter or a range of characterization parameters is associated with one assessment parameter in each case, according to a decision tree and/or according to an assessment formula.

16. The method as claimed in claim 9, wherein the evaluation algorithm comprises a trained algorithm that is trained on the basis of the series, and
wherein applying the evaluation algorithm generates, from an input of the at least one characterization parameter, the assessment parameter as an output.

17. A non-transitory computer readable medium having instructions stored thereon that, when executed by a controller of a medical imaging device, cause the medical imaging device to automatically rate image data in terms of an image quality that can be achieved with an image reconstruction procedure applied to the image data by:
receiving and/or generating at least one characterization parameter that characterizes a signal-to-noise ratio of the image data acquired by the medical imaging device, the at least one characterization parameter being used to control imaging parameters of the medical imaging device; and
applying an evaluation algorithm to the at least one characterization parameter,
wherein the evaluation algorithm is configured to generate, on the basis of the at least one characterization parameter, at least one assessment parameter comprising a qualitative value that characterizes the image quality that can be achieved with the image reconstruction procedure such that the at least one assessment parameter is generated as a rating of the achievable image quality for adjusting scan parameters of the medical imaging device.

18. A medical imaging device, comprising:
a main magnet, and
a controller configured to automatically rate image data in terms of an image quality that can be achieved with an image reconstruction procedure applied to the image data by:
receiving and/or generating at least one characterization parameter that characterizes a signal-to-noise ratio of the image data acquired by the medical imaging device, the at least one characterization parameter being used to control imaging parameters of the medical imaging device; and
applying an evaluation algorithm to the at least one characterization parameter,
wherein the evaluation algorithm is configured to generate, on the basis of the at least one characterization parameter, at least one assessment parameter comprising a qualitative value that characterizes the image quality that can be achieved with the image reconstruction procedure such that the at least one assessment parameter is generated as a rating of the achievable image quality for adjusting scan parameters of the medical imaging device.
